(19) United States
(12) Patent Application Publication
(10) Pub. No.: US 2008/0290798 A1
(43) Pub. Date: Nov. 27, 2008

(54) LLT barrier layer for top emission display device, method and apparatus

(76) Inventor: Mark Alejandro Quesada, Horseheads, NY (US)

Correspondence Address: CORNING INCORPORATED, SP-TI-3-1, CORNING, NY, 14831, US

(21) Appl. No.: 12/080,711

(22) Filed: Apr. 4, 2008

Related U.S. Application Data
(60) Provisional application No. 60/931,272, filed on May 22, 2007.

(51) Int. Cl. H01J 9/26; H01J 1/63

(52) U.S. Cl. 313/512; 445/25

(57) ABSTRACT

A method is disclosed for inhibiting oxygen and moisture penetration of a top emission device comprising the steps of depositing a low liquidus temperature (LLT) inorganic material on at least a portion of the top emission device to create a deposited LLT material, and optionally heat treating the deposited LLT material in a substantially oxygen and moisture free environment to form a LLT barrier layer, and optionally placing a cover glass over the LLT barrier layer. A top emission display device is also disclosed comprising a substrate, at least one electronic or optoelectronic layer, and a LLT barrier layer, wherein the electronic or optoelectronic layer is hermetically sealed between the LLT barrier layer and the substrate and an optional cover glass over the LLT barrier layer.

### CROSS REFERENCE TO RELATED APPLICATIONS

This application is related to and claims the benefit of co-pending and commonly assigned U.S. patent application Ser. No. 60/931,272, filed May 22, 2007, for LLT BARRIER LAYER FOR TOP EMISSION DISPLAY DEVICE.

### BACKGROUND OF THE INVENTION

1. Field of the Invention

The present invention relates to a method for inhibiting oxygen and moisture penetration, and the subsequent degradation of a device or apparatus.

2. Technical Background

The transport of oxygen or moisture through laminated or encapsulated materials and the subsequent attack of an inner material(s) represent two of the more common degradation mechanisms associated with many light emitting display devices such as, for example, organic light emitting diode display devices (OLED devices). The operational lifetime of such devices can be greatly increased if steps are taken to minimize the penetration of oxygen and/or moisture.

Existing efforts to extend the lifetime of such devices include gettering, encapsulation and extensive device sealing techniques. Common techniques for sealing devices, such as OLEDs, include the use of epoxies and inorganic and/or organic materials that form a hermetic seal upon curing by exposure to heating or to ultra-violet light. Although such seals provide some level of hermetic behavior, they can be expensive and do not assure hermetic seals will be maintained through prolonged operation.

Traditional OLED devices emit light from the bottom of the device, requiring the emitted light to pass through multiple material layers that can have varying refractive indices. Such a design can create light trapping events, resulting in reduced device efficiency, brightness, and increased power consumption. Accordingly, there is a need to improve the operating efficiency, brightness, and power consumption of display devices while inhibiting the penetration of oxygen and moisture. This need and other needs are satisfied by the present invention.

### SUMMARY OF THE INVENTION

The present invention relates to display devices and specifically to top emission organic light emitting display devices comprising a low liquidus temperature inorganic barrier layer. The present invention addresses at least a portion of the problems described above through the use of novel compositions and methods of manufacture.

In a first aspect, the present invention provides a method of inhibiting oxygen and moisture penetration of a top emission display device, comprising the steps of: depositing a low liquidus temperature inorganic material on at least a portion of the top emission device to create a deposited low liquidus temperature inorganic material; and optionally heat treating the deposited low liquidus temperature inorganic material in a substantially oxygen and moisture free environment to form a low liquidus temperature (LLT) barrier layer.

In a second aspect, the present invention provides a device produced by the methods of the present invention.

In a third aspect, the present invention provides a top emission display device comprising a substrate; at least one organic electronic or optoelectronic layer formed on the substrate; and a low liquidus temperature barrier layer formed over the at least one organic electronic or optoelectronic layer, wherein the electronic or optoelectronic layer is hermetically sealed between the low liquidus temperature barrier layer and the substrate; and a cover glass placed over the barrier layer.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the present invention and together with the description, serve to explain, without limitation, the principles of the invention.

FIG. 1 is a schematic illustration of an exemplary process of forming a LLT barrier layer on at least a portion of a device, in accordance with one aspect of the present invention.

FIG. 2 is a schematic of an exemplary top-emission device including a LLT barrier layer, in accordance with another aspect of the present invention.

FIG. 3 is a schematic of an exemplary top-emission device including a LLT barrier layer and a cover glass, in accordance with further aspect of the present invention.

### DETAILED DESCRIPTION OF THE INVENTION

The present invention can be understood more readily by reference to the following detailed description, examples, and claims, and their previous and following description. However, before the present device and/or methods are disclosed and described, it is to be understood that this invention is not limited to the specific devices and/or methods disclosed unless otherwise specified, as such can, of course, vary. It is also to be understood that the terminology used herein is for the purpose of describing particular aspects only and is not intended to be limiting.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a class of components A, B, and C are disclosed as well as a class of components D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

The following description of the invention is provided as an enabling teaching of the invention in its currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “low liquidus temperature inorganic material” includes aspects having two or more such materials, unless the context clearly indicates otherwise.

“Optional” or “optionally” means that the subsequently described event or circumstance can or cannot occur, and that the description includes instances where the event or circumstance occurs and instances where it does not. For example, the phrase “optionally substituted component” means that the component can or can not be substituted and that the description includes both unsubstituted and substituted components.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, unless specifically stated to the contrary, the terms “low liquidus temperature inorganic material”, “low liquidus temperature material”, and “LLT material” refer to a material with a melting point (Tm) or glass transition temperature (Tg) less than about 1,000° C.

As used herein, a “starting” material refers to a material that will be deposited onto a device.

As used herein, a “deposited” material refers to a material that has been deposited on a device or apparatus.

As used herein, a “barrier layer” refers to a hermetic coating, and specifically herein a deposited low liquidus temperature inorganic material that has been heat treated to a temperature effective to form a hermetic seal.

As briefly introduced above, the present invention provides an improved method for forming a LLT barrier layer on a top emission display device. Among other aspects described in detail below, the inventive method comprises the deposition of a LLT starting material onto at least a portion of a top emission display device to form a deposited LLT material, and heat treatment of the deposited LLT material to remove defects and/or pores and form a LLT barrier layer.

The LLT material can be deposited onto the top emission display device by any technique suitable for depositing the LLT material onto at least a portion of the device. The deposition can comprise, for example, at least one of a sputtering process, an evaporation process, a spraying process, a pouring process, a frit-deposition process, a vapor-deposition process, a dip-coating process, a painting process, a laser ablation process, a co-evaporation process, a rolling process, a spin-coating process, an irradiation process, or a combination thereof. In various aspects, the deposition is a thermal evaporation process, a co-evaporation process, a laser ablation process, a flash evaporation process, a vapor-deposition process, or an electron beam irradiation process. Defects and/or pores in the LLT material can be removed by a consolidation or heat treatment step to produce a pore-free or substantially pore-free, oxygen and moisture impenetrable protective coating on the device. Although many deposition methods are possible with common glasses (i.e. those having high melting temperatures), the consolidation step is only practical with a LLT material where the consolidation temperature is sufficiently low so as to not damage the inner layers in the device. In some aspects, the deposition step and/or heat treatment step take place in a vacuum, in an inert atmosphere, or in ambient conditions depending upon the LLT material's composition.

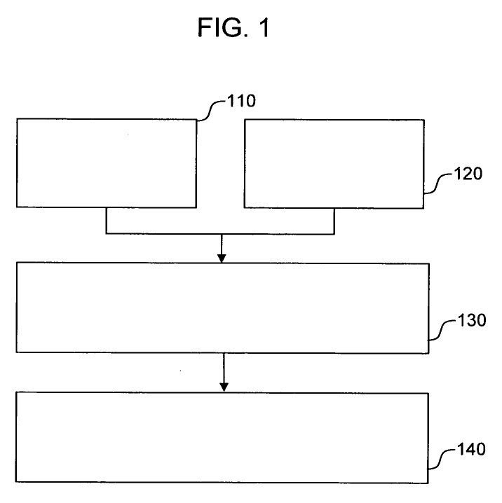

With reference to the drawings, the flowchart of FIG. 1 illustrates the steps of an exemplary method 100 for forming a LLT barrier layer on a top emission device. Beginning at steps 110 and 120, a device and a LLT starting material are provided so that one can form the desired LLT barrier layer on a device. At step 130, the LLT starting material is deposited on at least a portion of the device by, for example, a sputtering technique. Depending on the specific material and deposition conditions, the deposited LLT material can contain pores and can be remain permeable to oxygen and moisture. At optional step 140, the deposited LLT material may be heat treated to a temperature sufficient to remove pores, for example, a temperature approximately equal to the glass transition temperature of the deposited LLT material, and form a hermetic seal or LLT barrier layer, which can prevent oxygen and moisture penetration into the device.

The steps of the exemplary method are not intended to be limiting and can be performed in various orders. For example step 110 can be performed before, after, or simultaneous to step 120.

### Top Emission Display Devices

The device of the present invention can be any top emission display device where at least a portion of the device is sensitive to oxygen and/or moisture, for example, an organic-electronic device, such as an organic light emitting diode (“OLED”).

OLED technology, including active matrix OLEDs, can provide various advantages, such as improved color quality and brightness, reduced manufacturing and assembly cost, and smaller device size over other display technologies, such as LCD.

An OLED device comprises organic diodes that emit light when an electrical potential is applied. Traditional OLED devices are “bottom-emission” devices that contain a transparent conducting layer, such as indium tin oxide (ITO), optimized for injection of electron holes into the light emitting material. In such a configuration, light arising from the interior exciton recombination zone is required to pass through multiple layers of materials, such as, for example, electrodes, electronics, transistors, and substrate materials, that can have varying refractive indices, potentially creating light trapping events. This emission pathway can result in decreased OLED efficiency and can thus, require more power to operate the device.

Alternatively, top emission devices utilize patterned layers that are embedded with electronics, typically positioned on the bottom substrate. Top emission architecture can thus provide enhanced brightness by guiding light away from the bottom substrate, instead of through it as in traditional bottom-emission devices. In an exemplary configuration according to the present invention, emitted light can thus travel through a transparent conducting layer and a LLT barrier layer, and an optional cover glass overlying the LLT barrier layer, without significant loss in intensity, clarity, or image quality. This architecture can result in higher operating efficiency, brightness, and lower power consumption. Materials, such as ITO, can be utilized for cover glass and/or sealing applications, but can adversely affect device efficiency and brightness since ITO has a work function suited for the injection of electron holes. The barrier layer of the present invention is preferably used with a transparent conducting material having a work function more suitable for the injection of electrons into the light emitting layer, enabling improved performance and efficiency.

Other traditional technologies for hermetically sealing devices, such as epoxy seals with getters, do not allow for top emission architecture. Frit sealing approaches typically result in air gaps between the light emitting layer and the cover sheet that can also introduce light trapping events. In one aspect, the present invention provides a LLT barrier layer positioned between a light emitting layer and a glass cover sheet so as to minimize or eliminate an air gap in the device. In another aspect, the present invention provides a LLT barrier layer in lieu of a glass cover sheet, wherein the barrier layer is positioned over the light emitting and transparent conducting layers, thereby eliminating or substantially eliminating any potential air gap in the device.

In one aspect, the device is a top emission OLED device that has multiple inner layers, including a cathode and an electro-luminescent material, located on a substrate. The substrate can be any material suitable for fabricating and sealing a device. In one aspect, the substrate is glass. In another aspect, the substrate can be a flexible material. In one aspect, the LLT material is deposited prior to the deposition of an organic electro-luminescent material.

In another aspect, the device is a top emission display device comprising a substrate, as described above, at least one organic electronic or optoelectronic layer, and a transparent conducting layer. In a further aspect, the device is coated with a LLT barrier layer, wherein the organic electronic or optoelectronic layer and the transparent conducting layer are hermetically sealed between the substrate and the LLT barrier layer. In a further aspect, the hermetic seal is created by the deposition and heat treatment of a LLT material. In another aspect, at least a portion of the device is sealed with a LLT material. In yet a further aspect, a cover glass is provided over the LLT material.

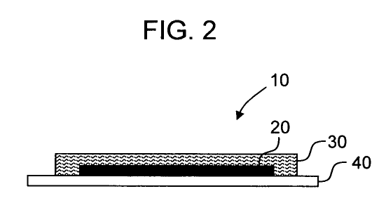

With reference again to the drawings, FIG. 2 depicts an exemplary cross-sectional side view of a device coated with a LLT barrier layer. The exemplary coated device 10 of FIG. 2 includes a substrate 40, an optoelectronic and/or transparent conducting layer 20 that is sensitive to oxygen and/or moisture, and a LLT barrier layer 30 that provides a hermetic seal between the optoelectronic and/or transparent conducting layer 20 and environmental oxygen and moisture.

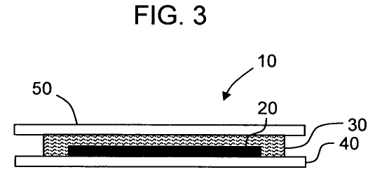

Referring now to FIG. 3, FIG. 3 depicts an exemplary cross-sectional side view of a device coated with a LLT barrier layer. The exemplary coated device 10 of FIG. 2 includes a substrate 40, an optoelectronic and/or transparent conducting layer 20 that is sensitive to oxygen and/or moisture, and a LLT barrier layer 30 that provides a hermetic seal between the optoelectronic and/or transparent conducting layer 20 and environmental oxygen and moisture; and a cover glass 50 overlying the LLT barrier layer 30. The LLT barrier layer 30 completely fills the space between the substrate 40 and the cover glass 50.

### Low Liquidus Temperature Inorganic Starting Material

In the present invention, the physical properties of a low liquidus temperature inorganic material facilitate the formation of a hermetic seal. In one aspect of the present invention, a low liquidus temperature inorganic starting material, or LLT starting material, can be deposited onto a least a portion of a top emission device and the deposited material may subsequently be heat treated at a relatively low temperature to obtain a pore-free or substantially pore-free barrier layer, without thermally damaging the device's inner layer(s).

The LLT starting material of the present invention can comprise any low liquidus temperature inorganic material suitable for use in hermetically sealing at least a portion of a top emission display device. In various aspects, the LLT starting material comprises a tin phosphate, a tin fluorophosphate, a chalcogenide, a tellurite, a borate, a phosphate, or a combination thereof. In a specific aspect, the LLT starting material is a tin fluorophosphate material, such as, for example Code 870CHM glass (available from Corning, Inc., Corning, N.Y., USA), comprising from about 20 wt. % to about 85 wt. % Sn, from about 2 wt. % to about 20 wt. % P, from about 10 wt. % to about 36 wt. % O, from about 10 wt. % to about 36 wt. % F, and optionally from about 0 wt. % to about 5 wt. % Nb, wherein the total of Sn, P, O, and F is at least about 75 wt. %. A particular LLT starting material can comprise various individual compounds and/or oxidation states. For example, a tin phosphate can comprise a tin meta-phosphate, a tin ortho-hydrogenphosphate, a tin ortho-dihydrogenphosphate, a tin pyrophosphate, or a mixture thereof.

In one aspect, the LLT starting material has a glass transition temperature of less than about 1000° C., preferably less than about 600° C., more preferably less than about 400° C., or yet more preferably less than about 150° C. In one specific aspect, the LLT starting material has a glass transition temperature of about 180° C. In another specific aspect, the LLT starting material has a glass transition temperature of about 100° C.

It is understood that the stoichiometry of the deposited LLT material can vary from that of the LLT starting material. For example, deposition of a tin pyrophosphate can produce a deposited material that is depleted or enriched in phosphorus relative to tin pyrophosphate.

The LLT starting material of the present invention can be crystalline, amorphous, glassy, or a mixture thereof. In one aspect, the LLT starting material can comprise at least one crystalline component. In another aspect, the LLT starting material can comprise at least one amorphous component. In yet another aspect, the LLT starting material can comprise at least one glassy component.

In one aspect, the LLT starting material is a single LLT material such as, for example, tin fluorophosphate, tin meta-phosphate, tin ortho-hydrogen phosphate, tin ortho-dihydrogen phosphate, or tin pyrophosphate. In another aspect, the LLT starting material can comprise a mixture of components. In another aspect, the LLT starting material can comprise a glass, formed by mixing at least two LLT materials, heating the materials to fuse them together, and quenching the resulting mixture to form a glass.

The LLT starting material can further comprise additives, dopants, and/or other low liquidus temperature materials. Additives and/or dopants can be utilized to adjust properties, such as, for example, the transparency, refractive index, coefficient of thermal expansion, solubility, wettability, density, or scratch resistance, of the LLT starting material, the deposited LLT material, the LLT barrier layer, or a combination thereof. LLT dopants can include, for example, P₂O₅, BPO₄, PbF₂, to adjust the refractive index of a LLT material. The transparency of a LLT barrier layer can also be adjusted with additives, such as, for example, a phosphate compound added to a LLT material comprising a tin oxide.

Dopant and/or additive materials can be added in any amount sufficient to achieve the desired result, provided that the LLT character of the barrier layer is maintained. Dopant and additive materials are known and one of skill in the art could readily select an appropriate dopant and/or additive material.

In one aspect, the LLT starting material comprises a niobium containing compound. In a further aspect, the LLT starting material comprises niobium oxide, at an amount from greater than 0 to about 10 weight percent, preferably at an amount from greater than 0 to about 5 weight percent, and more preferably at about 1 weight percent.

LLT starting materials are commercially available, for example, from Alfa Aesar, Ward Hill, Mass., USA. One of ordinary skill in the art should be able to readily select an appropriate LLT starting material.

### Depositions of LLT Starting Material

In the present invention, the LLT starting material can be deposited onto at least a portion of a device by any suitable process for creating a LLT barrier film. Exemplary deposition processes include a sputtering process, an evaporation process, a spraying process, a pouring process, a frit-deposition process, a vapor-deposition process, a dip-coating process, a painting process, a laser ablation process, a co-evaporation process, a rolling process, a spin-coating process, an irradiation process, or a combination thereof. In various aspects, the deposition is a sputtering process, thermal evaporation process, a co-evaporation process, a laser ablation process, a flash evaporation process, a vapor-deposition process, or an electron beam irradiation process. The deposition step of the present invention is not limited to any specific process, equipment, or geometric arrangement.

Deposition of a LLT starting material can be performed in an inert atmosphere to ensure substantially oxygen and moisture free conditions are maintained throughout the deposition and sealing process. Unless required by the nature of the top emission device to be coated, it is not necessary that the deposition and/or heat treatment environment be completely free of oxygen and moisture, and so, the environment can be free of or substantially free of oxygen and moisture.

The specific deposition conditions (e.g., power, deposition rate, etc.) can vary depending upon the deposition method and the specific LLT starting material(s) to be deposited. Deposition systems commercially available, for example, from Kurt J. Lesker Company, Clairton, Pa., USA. One of ordinary skill in the art could readily select a deposition system and the operating conditions necessary to deposit a LLT starting material.

In one aspect, a single layer of a LLT material can be deposited on at least a portion of a substrate. In another aspect, multiple layers of the same or varying types of LLT material can be deposited over one or more inner layers, positioned on top of a substrate.

In another aspect, the deposited LLT material can contain other materials to provide improved strength or resistance to permeability, or to alter the optical and/or electrical properties of the device. These materials can be evaporated together with the LLT starting material. In one aspect, the deposited LLT material can contain niobium, for example, in the form of niobium oxide. In another aspect, the deposited LLT material can contain a P₂O₅ dopant. Additives, such as niobium oxide, and dopants are commercially available (e.g., Alfa Aesar, Ward Hill, Mass., USA) and one of ordinary skill in the art could readily select an appropriate additional material, such as a niobium oxide.

### Heat Treatment and Formation of LLT Barrier Layer

An optional heat treatment or annealing step may be employed to minimize defects and pores in the deposited layer of LLT material, allowing the formation of a hermetic seal or LLT barrier layer. In one aspect, the LLT barrier layer is deposited pin hole and pore-free or substantially pin hole pore-free, and forms a substantially hermetic barrier without any subsequent heat treatment. In another aspect, the deposited LLT barrier is subsequently heat treated to remove any pinholes or pores, such that the heat treated LLT barrier layer is pin hole and pore-free or substantially pin hole pore-free. The number and/or size of pores remaining in the heat treated LLT barrier layer should be sufficiently low to prevent oxygen and moisture penetration. In one aspect, the heat treatment is performed under vacuum. In another aspect, the heat treatment step is performed in an inert atmosphere. It should be appreciated that the heat treatment step can be performed in the same system and immediately subsequent to the deposition step, or at a separate time and place provided that environmental conditions are maintained to prevent oxygen and moisture intrusion into the device.

The heat treatment step of the present invention comprises heating the device onto which a LLT material has been deposited. In one aspect, the temperature to which the device and deposited LLT material are exposed is approximately equal to the glass transition temperature, or Tg, of the deposited LLT material. In another aspect, the temperature to which the device and deposited LLT material are exposed is within approximately 50° C. of the glass transition temperature, or Tg, of the deposited LLT material. In another aspect, the temperature to which the device and deposited LLT material are exposed is from about 200° C. to about 350° C., for example, 200, 225, 250, 275, 300, 325, or 350° C. In yet another aspect, the temperature to which the device and deposited LLT material are exposed is from about 250° C. to about 270° C. It will be appreciated that the ideal time and temperature to which a device and deposited LLT material are exposed will vary, depending on factors such as the composition of the deposited LLT material, the working temperature range of the components to be sealed, and the desired thickness and permeability of the hermetic seal. The heat treatment step can be performed by any heating means that can achieve the desired temperature and maintain a substantially oxygen and moisture free environment. The duration and temperature of a heat treatment step can be dependent on the onset of degradation in a device, which can be dependent on the device dimensions and materials of construction. In one aspect, the heat treatment step comprises heating the device with an infrared lamp positioned in a vacuum deposition chamber. In another aspect, the heat treatment step comprises raising the temperature of a deposition chamber and/or a substrate holder positioned within the deposition chamber in which the device is located. The heat treatment step can be performed separately from the deposition step, provided that a substantially oxygen and moisture free environment is maintained. It is preferable that the heat treatment conditions be sufficient to allow the resulting device to meet desired performance criteria, such as the calcium patch test described below. One of ordinary skill in the art could readily choose appropriate heat treatment conditions to for a hermetic seal without damage to the device.

The thickness of the LLT barrier layer can be any such thickness required to provide the desired hermetic seal. In one aspect, the LLT barrier layer is about 1 micrometer thick. In another aspect, the LLT barrier is about 2.5 micrometers thick.

In one aspect, the LLT barrier layer is at least substantially transparent to radiation either emitted by or absorbed by the device. In another aspect, the LLT barrier layer is at least substantially transparent to visible light. In yet another aspect, the LLT barrier layer is transparent and does not absorb light emitted from the top emission display device.

The refractive index of a LLT barrier layer can be adjusted using additives so that it is substantially similar to other device components in the light path. In one aspect, the LLT barrier layer has a refractive index that is substantially similar to the glass cover sheet. In various aspects, a substantially similar refractive index can be within about 0.5, such as for example about 0.5, 0.4, 0.3, 0.2, 0.1, or 0.05; within about 0.2, for example, 0.2, 0.1, 0.08, 0.05, or 0.02; or within about 0.1, for example, about 0.1, 0.08, 0.05, 0.03, 0.02, or 0.01 of another device component. In another aspect, the difference in refractive indices between the LLT barrier layer and another device component can be greater than about 0.5.

The LLT barrier layer of the present invention can also have a coefficient of thermal expansion substantially similar to other device components. In one aspect, the LLT barrier layer has a coefficient of thermal expansion similar to or substantially similar to that of copper.

### Evaluation of Barrier Layer

The hermeticity of a LLT barrier layer can be evaluated using various methods to test the hermeticity of the LLT barrier layer to oxygen and/or moisture. In one aspect, the LLT barrier layer can be evaluated using a calcium patch test, wherein a thin calcium film is deposited onto a substrate. A LLT barrier layer is then formed, sealing the calcium film between the LLT barrier layer and the substrate. The resulting device is then subjected to environmental aging at a selected temperature and humidity, for example, 85° C. and 85% relative humidity. If oxygen and/or moisture penetrate the LLT barrier layer, the highly reflective calcium film will react, producing an easily identifiable opaque white crust. It is generally recognized in the display industry that calcium patch survival for about 1,000 hours in an 85° C., 85% relative humidity environment indicates the hermetic layer can prevent oxygen and water permeation for at least about 5 years.

### EXAMPLES

To further illustrate the principles of the present invention, the following examples are put forth so as to provide those of ordinary skill in the art with a complete disclosure and description of how the devices and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations can have occurred. Unless indicated otherwise, percents are weight percent, and temperature is ° C. or is at ambient temperature. There are numerous variations and combinations of process conditions, e.g., component concentrations, temperatures, pressures and other reaction ranges and conditions that can be used to optimize the product purity and performance obtained from the described process. Only reasonable and routine experimentation will be required to optimize such process conditions.

### Example 1

### Calcium Patch Accelerated Testing

In a first example, a calcium patch test device was prepared. The test device consisted of a Corning 1737 glass substrate (approximately 1 millimeter thick and 2.5 inches square), onto which a 100 nanometer thick calcium film (approximately 1 inch by 0.5 inch) was deposited, and onto which a 200 nanometer thick aluminum layer (approximately 1 inch by 0.5 inch) was deposited. The test device was affixed to moveable platform in the vacuum deposition chamber.

The calcium patch test device was subsequently sealed with a deposited LLT material, as detailed in Table 1. The sealed device was then exposed to conditions designed to mimic long term operation of a device, such as an OLED. Industry standard conditions for accelerated aging require a device to withstand 1000 hours in an 85° C. and 85% relative humidity environment. Upon exposure to moisture or oxygen, by permeation through the LLT layer, the calcium reacts and changes from a highly reflective film to an opaque white crust. Optical photographs were acquired at regular time intervals to quantify the evolution of the test device and thus, determine the hermetic strength of the LLT layer. Table 1 below details calcium patch experiments on devices prepared as in examples above.

TABLE 1
Calcium Patch Accelerated Aging Test

| | | Heat | |
|---|---|---|---|
| Sample | Starting LLT Material | Treatment | Aging Test |
| Ex. A | 870CHM (sputtered) | 120 ° C. | >1000 hrs |
| Ex. B | Sn₂P₂O₇ (evaporated from W boat) | 270 ° C. | >1000 hrs |
| Ex. C | 870CHP (sputtered) | 120 ° C. | >1000 hrs |

Examination of the data in Table 1 indicates that the low temperature materials can produce hermetic barrier layers that can enable top emitting display devices.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A method of inhibiting oxygen and moisture penetration of a top emission display device, comprising the steps of:
a. providing a substrate with at least one organic electronic or optoelectronic layer formed thereon;
b. depositing a low liquidus temperature (LLT) inorganic material over at least a portion of the at least one organic electronic or optoelectronic layer in a substantially oxygen and moisture free environment to form a LLT inorganic barrier layer over the display device; and
c. positioning a glass cover sheet over the LLT inorganic barrier layer.

2. The method of claim 1, wherein the low liquidus temperature inorganic material comprises a tin phosphate material, a tin fluorophosphate, or a combination thereof.

3. The method of claim 1, wherein the low LLT inorganic material has a liquidus temperature of less than about 600° C.

4. The method of claim 1, wherein the LLT inorganic material is substantially transparent.

5. The method of claim 1, wherein the LLT inorganic material comprises a dopant.

6. The method of claim 5, wherein the LLT inorganic material has a refractive index substantially similar to the glass cover sheet.

7. The method of claim 5, wherein the depositing and positioning are performed such that there is substantially no air gap between the LLT inorganic material and the glass cover sheet over the display area of the device.

8. The method of claim 1, wherein the depositing comprises at least one of a sputtering process, an evaporation process, a spraying process, a pouring process, a frit-deposition process, a vapor-deposition process, a dip-coating process, a painting process, a laser ablation process, a co-evaporation process, a rolling process, a spin-coating process, an irradiation process, or a combination thereof.

9. The method of claim 1, wherein the heat treating is performed in a vacuum or an inert environment and at a temperature which does not damage components in the device.

10. A device produced by the method of claim 1.

11. A top emission display device comprising:
a substrate;
at least one organic electronic or optoelectronic layer; and
a low liquidus temperature inorganic barrier layer, wherein the electronic or optoelectronic layer is hermetically sealed between the low liquidus temperature inorganic barrier layer and the substrate; and
wherein the at least one organic electronic or optoelectronic layer, and the low liquidus temperature inorganic barrier layer are positioned in a top emission configuration.

12. The top emission display device of claim 11, wherein the low liquidus temperature inorganic barrier layer comprises a tin phosphate material, a tin fluorophosphate material, or a combination thereof.

13. The top emission display device of claim 11, wherein the low liquidus temperature inorganic barrier layer has a liquidus temperature of less than about 600° C.

14. The top emission display device of claim 11, wherein the low liquidus temperature inorganic barrier layer is substantially transparent.

15. The top emission display device of claim 11, wherein the low liquidus temperature inorganic barrier layer comprises a dopant.

16. The top emission display device of claim 11, further comprising a glass cover sheet positioned on at least a portion of the device.

17. The top emission display device of claim 16, wherein the low liquidus temperature inorganic barrier layer has a refractive index substantially similar to the glass cover sheet.

18. The top emission display device of claim 16, wherein the device has substantially no air gap between the low liquidus temperature inorganic barrier layer and the glass cover sheet.
